(19) United States
(12) Patent Application Publication
(10) Pub. No.: US 2026/0295421 A1
(43) Pub. Date: Oct. 1, 2026

(54) CONTENT GENERATION METHOD AND APPARATUS, AND NON-TRANSITORY COMPUTER-READABLE STORAGE MEDIUM

(71) Applicant: Beijing Zitiao Network Technology Co., Ltd., Beijing (CN)

(72) Inventors: Zhanpeng SUN, Beijing (CN); Zijian ZHANG, Beijing (CN)

(21) Appl. No.: 19/163,351

(22) PCT Filed: Jul. 30, 2024
(86) PCT No.: PCT/CN2024/108470

§ 371 Date: Sep. 8, 2025

(30) Foreign Application Priority Data
Nov. 27, 2023 (CN) 202311598850.1

(51) Int. Cl. A63F 13/58; A63F 13/53

(52) U.S. Cl. CPC A63F 13/58; A63F 13/53

(57) ABSTRACT

The present disclosure relates to a content generation method and apparatus, and a non-transitory computer-readable storage medium, and relates to the field of computer technology. The content generation method includes: acquiring related information of a first virtual object and related information of a second virtual object for a confrontation, the related information being configured to describe describing an attribute feature of a virtual object; and generating, according to the related information of the first virtual object and the related information of the second virtual object, plot content describing the confrontation of the first virtual object and the second virtual object.

### CROSS-REFERENCE TO RELATED APPLICATIONS

The present application is based on and claims the priority of the Chinese application No. 202311598850.1 filed on Nov. 27, 2023, the disclosure of which is incorporated herein in its entirety.

### TECHNICAL FIELD

The present disclosure relates to the field of computer technology, and in particular, to a content generation method, a content generation apparatus, and a non-transitory computer-readable storage medium.

### BACKGROUND

In a computer application such as game and interactive story, a confrontation scene between virtual objects is often involved. Such a confrontation scene can be presented in various implementation forms.

In the related art, virtual objects can be controlled to confront with each other according to various operations input by a user; and the confrontation scene can also be presented by using pre-generated fixed text content.

### SUMMARY

According to some embodiments of the present disclosure, there is provided a content generation method, including: acquiring related information of a first virtual object and related information of a second virtual object for a confrontation, the related information being configured to describe an attribute feature of a virtual object; and generating, according to the related information of the first virtual object and the related information of the second virtual object, plot content describing the confrontation of the first virtual object and the second virtual object.

In some embodiments, the related information includes at least one of a character attribute or a skill attribute of the virtual object, and the generating the plot content describing the confrontation of the first virtual object and the second virtual object includes: determining the plot content according to at least one of a result of comparison between a character attribute of the first virtual object and a character attribute of the second virtual object, or a result of comparison between a skill attribute of the first virtual object and a skill attribute of the second virtual object.

In some embodiments, the plot content includes description content of the first virtual object casting a first skill and description content of the second virtual object casting a second skill.

In some embodiments, the plot content includes description content of a reaction of the first virtual object to the second skill and description content of a reaction of the second virtual object to the first skill.

In some embodiments, the character attribute includes current hit point information of a character, and the skill attribute includes skill information acquired by the character in a previous plot of interactive multimedia content.

In some embodiments, the generating the plot content describing the confrontation of the first virtual object and the second virtual object includes: determining, according to the previous plot of the interactive multimedia content, at least one of a first associated virtual object of the first virtual object or a second associated virtual object of the second virtual object; and generating plot content describing a confrontation of a first virtual object set and a second virtual object set, the first virtual object set including at least one of the first virtual object or the first associated virtual object, the second virtual object set including at least one of the second virtual object or the second associated virtual object.

In some embodiments, the generating the plot content describing the confrontation of the first virtual object set and the second virtual object set includes: determining, according to the previous plot, at least one of a first combining skill attribute of the first virtual object and the first associated virtual object, or a second combining skill attribute of the second virtual object and the second associated virtual object; and generating the plot content according to at least one of the first combining skill attribute or the second combining skill attribute.

In some embodiments, the generating the plot content describing the confrontation of the first virtual object and the second virtual object includes: generating content prompt information according to the related information of the first virtual object and the related information of the second virtual object; and generating the plot content by using a machine learning model according to the content prompt information.

In some embodiments, the content generation method further includes: presenting the plot content to a user, the plot content including at least one of text content or image content.

In some embodiments, the image content is generated according to the text content.

In some embodiments, the text content includes a plurality of paragraphs, and the image content includes a plurality of images, each paragraph of the plurality of paragraphs being presented together with a corresponding image.

In some embodiments, the image content is video content generated according to the plurality of images.

In some embodiments, content corresponding to the first virtual object and content corresponding to the second virtual object in the text content are different in a text style.

In some embodiments, the text content includes a plurality of paragraphs, and the presenting the plot content to the user includes: presenting the plurality of paragraphs to the user concurrently; or presenting one paragraph of the plurality of paragraphs to the user each time in an order of occurrence of the plurality of paragraphs.

In some embodiments, the plot content includes confrontation process content and confrontation result content.

According to other embodiments of the present disclosure, there is provided a content generation apparatus, including: an acquisition unit configured to acquire related information of a first virtual object and related information of a second virtual object for a confrontation, the related information being configured to describe an attribute feature of a virtual object; and a generation unit configured to generate, according to the related information of the first virtual object and the related information of the second virtual object, plot content describing the confrontation of the first virtual object and the second virtual object.

In some embodiments, the related information includes at least one of a character attribute or a skill attribute of the virtual object, and the generation unit determines the plot content according to at least one of a result of comparison between a character attribute of the first virtual object and a character attribute of the second virtual object, or a result of comparison between a skill attribute of the first virtual object and a skill attribute of the second virtual object.

In some embodiments, the plot content includes description content of the first virtual object casting a first skill and description content of the second virtual object casting a second skill.

In some embodiments, the plot content includes description content of a reaction of the first virtual object to the second skill and description content of a reaction of the second virtual object to the first skill.

In some embodiments, the character attribute includes current hit point information of a character, and the skill attribute includes skill information acquired by the character in a previous plot of interactive multimedia content.

In some embodiments, the generation unit determines, according to the previous plot of the interactive multimedia content, at least one of a first associated virtual object of the first virtual object or a second associated virtual object of the second virtual object, and generates the plot content describing a confrontation of a first virtual object set and a second virtual object set, the first virtual object set including at least one of the first virtual object or the first associated virtual object, and the second virtual object set including at least one of the second virtual object or the second associated virtual object.

In some embodiments, the generation unit determines, according to the previous plot, at least one of a first combining skill attribute of the first virtual object and the first associated virtual object, or a second combining skill attribute of the second virtual object and the second associated virtual object; and generates the plot content according to at least one of the first combining skill attribute or the second combining skill attribute.

In some embodiments, the generation unit generates content prompt information according to the related information of the first virtual object and the related information of the second virtual object, and generates the plot content by using a machine learning model according to the content prompt information.

In some embodiments, the content generation apparatus further includes: a presentation unit configured to present the plot content to a user, the plot content including at least one of text content or image content.

In some embodiments, the image content is generated according to the text content.

In some embodiments, the text content includes a plurality of paragraphs, and the image content includes a plurality of images, each paragraph of the plurality of paragraphs being presented together with a corresponding image.

In some embodiments, the image content is video content generated according to the plurality of images.

In some embodiments, content corresponding to the first virtual object and content corresponding to the second virtual object in the text content are different in a text style.

In some embodiments, the text content includes a plurality of paragraphs, and the presentation unit presents the plurality of paragraphs to the user concurrently, or presents one paragraph of the plurality of paragraphs to the user each time in an order of occurrence of the plurality of paragraphs.

In some embodiments, the plot content includes confrontation process content and confrontation result content.

According to still other embodiments of the present disclosure, there is provided a content generation apparatus, including: a memory; and a processor coupled to the memory, the processor being configured to perform, based on instructions stored in the memory, a content generation method in any of the above embodiments.

According to further embodiments of the present disclosure, there is provided a non-transitory computer-readable storage medium having thereon stored a computer program which, when executed by a processor, implements a content generation method in any of the above embodiments.

### BRIEF DESCRIPTION OF THE DRAWINGS

The accompanying drawings, which constitute a part of this specification, describe embodiments of the present disclosure and together with the specification, serve to explain the principles of the present disclosure.

The present disclosure may be more clearly understood according to the following detailed description with reference to the accompanying drawings, in which:

FIG. 1 illustrates a flow diagram of a content generation method according to some embodiments of the present disclosure;

FIGS. 2a-2e illustrate schematic diagrams of presentation of plot content according to some embodiments of the present disclosure;

FIGS. 3a-3d illustrate schematic diagrams of presentation of plot content according to other embodiments of the present disclosure;

FIG. 4 illustrates a block diagram of a content generation apparatus according to some embodiments of the present disclosure;

FIG. 5 illustrates a block diagram of a content generation apparatus according to other embodiments of the present disclosure;

FIG. 6 illustrates a block diagram of a content generation apparatus according to yet other embodiments of the present disclosure.

### DETAILED DESCRIPTION

Various exemplary embodiments of the present disclosure will now be described in detail with reference to the accompanying drawings. It should be noted that: the relative arrangement of components and steps, numerical expressions and numerical values set forth in these embodiments do not limit the scope of the present disclosure unless specifically stated otherwise.

Meanwhile, it should be understood that the sizes of the parts shown in the drawings are not drawn to actual scale for the convenience of description.

The following description of at least one exemplary embodiment is merely illustrative in nature and is in no way intended to limit this disclosure and its application or use.

Techniques, methods, and devices known to one of ordinary skill in the related art may not be discussed in detail, but they should be considered as part of the description where appropriate.

In all examples shown and discussed here, any specific value should be construed as exemplary only and not as limiting. Thus, other examples of the exemplary embodiments may have different values.

It should be noted that: similar reference numbers and letters refer to similar items in the following drawings, and thus, once an item is defined in one drawing, it need not be discussed further in subsequent drawings.

The inventors of the present disclosure have found that in the related art described above, there are the following problems: the need of cumbersome and frequent interaction operations for a confrontation, or inability of accurate presentation of a confrontation scene under the current situation, resulting in a poor interaction effect of the computer application under the confrontation scene.

In view of this, the present disclosure provides a content generation technical solution, capable of improving an interaction effect of a computer application under the confrontation scene.

As previously described, the confrontation scene may be presented in two forms.

The first presentation form is that virtual objects are controlled to confront with each other according to various operations input by a user. For example, in a confrontation scene such as a fighting game, a character controlled by a user serves as one party of confrontation, and another character controlled by another user or directly set in the game serves as the other party of the confrontation. The user needs to continuously perform game operations (such as selecting a skill) to promote the confrontation in the game.

However, in some cases, the confrontation scene is only a part of game plots. The user's intention includes only understanding the confrontation process, rather than spending time and efforts to actively perform the game operation. In the process of presenting the confrontation scene, the user needs to perform an operation such as selecting a game mode, resulting in a significant operation burden of the user. Therefore, confrontation operations required by this presentation form are cumbersome, resulting in a poor human-computer interaction effect.

In addition, the presentation of the confrontation scene by using a plurality of frames of pictures will generate significant server processing and traffic transmission burden. So, non-smoothness such as lagging will occur in the game, resulting in a poor human-computer interaction effect.

The second presentation form is text presentation, i.e. presenting the confrontation scene directly by text. The text is pre-determined and then presented, and therefore, the confrontation scene expressed by the text is fixed, similar to a process of directly reading a novel.

Therefore, the second presentation form has a limitation that a confrontation scene with a determined process can only be presented, with poor flexibility, resulting in a poor human-computer interaction effect.

In view of the above technical problems, plot content of confrontation can be generated by the technical solutions of the present disclosure to improve the interaction effect of the computer application under the confrontation scene. For example, the technical solutions of the present disclosure can be implemented by the following embodiments.

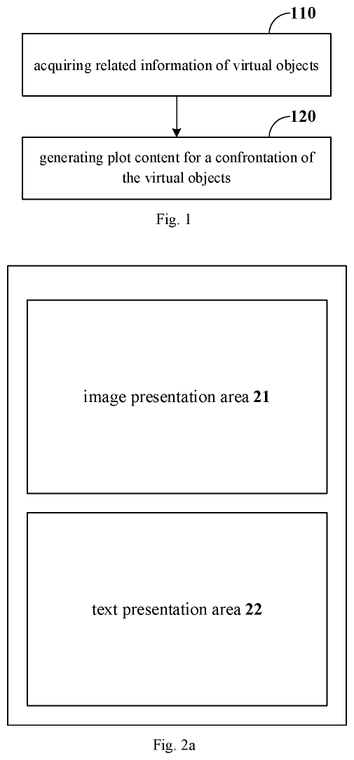

FIG. 1 illustrates a flow diagram of a content generation method according to some embodiments of the present disclosure.

As shown in FIG. 1, the content generation method includes: step 110, acquiring related information of a first virtual object and related information of a second virtual object for a confrontation; and step 120, generating, according to the related information of the first virtual object and the related information of the second virtual object, plot content describing the confrontation of the first virtual object and the second virtual object.

In this way, a matched confrontation plot can be generated according to attribute features of the virtual objects currently for a confrontation. On one hand, cumbersome and frequent user operations are reduced, and the confrontation plot matched with the current confrontation scene can be adaptively generated; on the other hand, a server is avoided to present the confrontation plot by processing a large number of pictures, reducing processing and transmission burden. Therefore, the interaction effect of the computer application under the confrontation scene is improved.

In the step 110, the related information of the first virtual object and the related information of the second virtual object for a confrontation are acquired. The related information is configured to describe an attribute feature of a virtual object. For example, the related information includes at least one of a character attribute or a skill attribute of the virtual object.

In some embodiments, the related information may be determined according to a previous plot of interactive multimedia content. For example, the interactive multimedia content includes game, interactive story, interactive comics, interactive episodes, and the like.

For example, the related information of the virtual object may be acquired from a stored virtual object database. The current character attribute of the virtual object can be acquired from an attribute database; and a skill attribute of a skill held by the virtual object can be acquired from a skill database.

The character attribute and the skill attribute in the related information are exemplified below by some embodiments.

In some embodiments, after virtual objects of both parties for a confrontation are determined, the character attributes and the skill attributes of the virtual objects of the both parties may be determined. For example, according to a previous plot related to the virtual object, various current character attributes of the virtual object as well as various skills held thereby and skill attributes thereof can be determined.

For example, the character attribute of the virtual object can include current hit point, magic point, ability point, and other attributes. A value corresponding to each character attribute can be determined according to an experience, behavior and the like of the virtual object in a previous plot.

For example, according to a skill obtained by a user in a main plot of multimedia interactive content, a skill held by a virtual object and a skill attribute thereof can be determined. The skill attribute can include a skill name, skill effect, skill damage value, and the like.

For example, currently in a main plot, a user obtains skill A and skill B. For these skills already obtained by the user, skill attributes of these skills can be determined, e.g., a hit point etc. of the other party that can be reduced in the case where these skills are released.

How to acquire the character attribute and the skill attribute is exemplified below by some embodiments.

In some embodiments, two virtual objects for a confrontation include a user character A and a confrontation character B, and as can be acquired from a main plot: currently, a hit point of the user character A being <character A hit point>, and a hit point of the confrontation character B being <confrontation character B hit point>; a skill held by the user character A being <user character A skill>, and a skill held by the confrontation character B being <confrontation character B skill>; and from a storage database <skill database> for the skills, acquire skill attributes of the skills.

How both parties for confrontation are determined is exemplified below by some embodiments.

In some embodiments, in the confrontation scene, there is a need to first determine characters of both parties for confrontation. For example, the both parties for confrontation can be single virtual object or teams formed by a plurality of virtual objects.

In some embodiments, at least one of a first associated virtual object of the first virtual object or a second associated virtual object of the second virtual object is determined according to a previous plot of interactive multimedia content; and a first virtual object set and a second virtual object set for confrontation are determined. For example, the first virtual object set includes at least one of the first virtual object or the first associated virtual object, and the second virtual object set includes at least one of the second virtual object or the second associated virtual object.

For example, it is possible to determine other virtual objects that may form a team with the virtual object, according to other virtual objects encountered by the virtual object in a previous plot, an interaction with other virtual objects, a behavior of the virtual object, and the like.

In some embodiments, the characters of the both parties for confrontation may be in a one-to-one form (e.g., the first virtual object confronting the second virtual object), one-to-many form (e.g., the first virtual object confronting the second virtual object and its second associated virtual object, or the second virtual object confronting the first virtual object and its first associated virtual object), or many-to-many form (e.g., the first virtual object and its first associated virtual object confronting the second virtual object and its second associated virtual object).

For example, in response to a first virtual object encountering a second virtual object, it is possible to determine, according to a previous plot, a plurality of first associated virtual objects that can, together with the first virtual object, form a team for confronting the second virtual object; and it is also possible to determine, according to a previous plot, a plurality of second associated virtual objects that can, together with the second virtual object, form a team for confronting the first virtual object. Therefore, two teams for confrontation are determined, or one team for confrontation with one virtual object is determined.

After the virtual objects of the both parties for confrontation are determined and the related information of the virtual objects is acquired, the step 120 in FIG. 1 of generating the plot content of the confrontation may be continued.

In the step 120, the plot content describing confrontation of the first virtual object and the second virtual object is generated according to the related information of the first virtual object and the related information of the second virtual object.

In the above embodiments, the matched confrontation plot is generated according to the attribute features of the virtual objects currently for confrontation. In this way, not only are cumbersome and frequent user operations reduced, but also the confrontation plot matched with the current confrontation scene can be adaptively generated. Therefore, the interaction effect of the computer application under the confrontation scene is improved.

In some embodiments, content prompt information is generated according to the related information of the first virtual object and the related information of the second virtual object; and the plot content is generated by using a machine learning model according to the content prompt information. For example, the machine learning model may be an NLP (Natural Language Processing) model such as LLM (Large Language Model), which can generate natural language content according to provided prompt information. In this way, the generation quality of the plot content can be improved by the machine learning model, thereby improving the effect of human-computer interaction.

How to generate the content prompt information as the prompt information for input of the machine learning model is exemplified below by some embodiments.

In some embodiments, by the above embodiments regarding the step 110, it is possible to determine that two virtual objects for confrontation include: a user character A and a confrontation character B; and that character attributes acquired from a main plot include: a current hit point of the user character A being <character A hit point>, a current hit point of the confrontation character B being <confrontation character B hit point>, a skill held by the user character A being <user character A skill>, and a skill held by the confrontation character B being <confrontation character B skill>; and acquire, from a storage database <skill database> for the skills, skill attributes of the skills.

On this basis, for example, it is possible to generate, as content prompt information, the following prompt information “There are two characters, including <user character A> and <confrontation character B>, currently, a hit point of <user character A> being <character A hit point>, a hit point of <confrontation character B> being <confrontation character B hit point>, a skill held by <user character A> being <user character A skill>, and a skill held by <confrontation character B> being <confrontation character B skill>; the above information can be acquired from a main plot, and for skill attributes of the skills, reference can be made to a storage database <skill database> for the skills; please generate plot content of a confrontation process according to the above information, to describe the confrontation process between <user character A> and <confrontation character B>, and give a result of the confrontation”.

In some embodiments, by the above embodiments regarding the step 110, it is possible to determine that two virtual objects for confrontation include: a user character A and a confrontation character B; it is possible to determine, according to a plot related to the user character A, that an associated character which can form a team with the user character A for confrontation with the confrontation character B includes an associated character A1; character attributes acquired from a main plot include: a current hit point of the user character A being <character A hit point>, a current hit point of the associated character A1 being <character A1 hit point>, a hit point of the confrontation character B being <confrontation character B hit point>, a skill held by the user character A being <user character A skill>, a skill held by the associated character A1 being <user character A1 skill>, and a skill held by the confrontation character B being <confrontation character B skill>; and acquire, from a storage database <skill database> for the skills, skill attributes of the skills.

On this basis, for example, it is possible to generate, as content prompt information, the following prompt information “There are three characters, including <user character A>, <associated character A1> and <confrontation character B>, currently, a hit point of <user character A> being <character A hit point>, a hit point of <associated character A1> being <associated character A1 hit point>, a hit point of <confrontation character B> being <confrontation character B hit point>, a skill held by <user character A> being <user character A skill>, a skill held by <associated character A1> being <associated character A1 skill>, a skill held by <confrontation character B> being <confrontation character B skill>; the above information can be acquired from a main plot, and for skill attributes of the skills, reference can be made to a storage database <skill database> for the skills; please generate plot content of a confrontation process according to the above information, to describe the confrontation process between a team formed by <user character A> and <associated character A1> with <confrontation character B>, and give a result of the confrontation”,.

After the above prompt information is generated, the above prompt information may be input into the machine learning model to generate plot content under a confrontation scene.

In some embodiments, the plot content includes confrontation process content and confrontation result content.

For example, the machine learning model can generate the confrontation process content according to the skill attributes of the virtual objects in the prompt information. For example, the confrontation process content can include a description of the virtual object casting a skill held by it, such as “The first virtual object casts a skill A”, and a description of a reaction of the virtual object to the skill, such as “The second virtual object dodges and casts a skill B”.

For example, the machine learning model can determine a confrontation result and generate confrontation result content according to the character attributes, the skill attributes, and the like of the virtual objects in the prompt information. For example, the confrontation result content can include description content of winner and loser of this confrontation, such as “Finally, the first virtual object defeats the second virtual object”.

In some embodiments, the plot content is determined according to at least one of a result of comparison between a character attribute of the first virtual object and a character attribute of the second virtual object, or a result of comparison between a skill attribute of the first virtual object and a skill attribute of the second virtual object.

For example, the machine learning model can determine winner and loser of this confrontation according to the character attributes such as the hit point of the first virtual object and the hit point of the second virtual object in the prompt information, in combination with the skill attributes such as the damage value of the skill casted by the first virtual object and the damage value of the skill casted by the second virtual object.

In this way, the matching degree between the plot content and the current situation can be improved, thereby improving the effect of the human-computer interaction.

The generation of the plot content in case of team confrontation is exemplified below by some embodiments.

In some embodiments, at least one of a first associated virtual object of the first virtual object or a second associated virtual object of the second virtual object is determined according to a previous plot of interactive multimedia content; and plot content describing a confrontation of a first virtual object set and a second virtual object set is generated. The first virtual object set includes at least one of the first virtual object or the first associated virtual object, and the second virtual object set includes at least one of the second virtual object or the second associated virtual object.

For example, according to a plot related to a user character A, it is possible to determine an associated character A1 that can form a team A with the user character A for confrontation with a confrontation character B; where character attributes acquired from a main plot include: a current hit point of the user character A being <character A hit point>, a current hit point of the associated character A1 being <character Al hit point>, a hit point of the confrontation character B being <confrontation character B hit point>, a skill held by the user character A being <user character A skill>, a skill held by the associated character A1 being <user character A1 skill>, and a skill held by the confrontation character B being <confrontation character B skill>; and acquire, from a storage database <skill database> for the skills, skill attributes of the skills.

The prompt information based on the above information may be input into the machine learning model, to generate the plot content for the confrontation of the team A and the confrontation character B.

For example, the machine learning model can generate confrontation process content according to the skill attributes of the virtual objects in the team A and the skill attribute of the confrontation character B in the prompt information. For example, the confrontation process content can include a description of the virtual object casting a skill held by it, such as “The user character A casts a skill A, and the associated character A1 casts a skill A1”, and description content of a reaction of the virtual object to the skill, such as “The confrontation character B dodges and casts a skill B.”

For example, the machine learning model can determine, according to results of comparison between the character attributes and the skill attributes of the virtual objects in the team A and a character attribute and skill attribute of the confrontation character B in the prompt information, a confrontation result and generate confrontation result content. For example, the confrontation result content can include description content of winner and loser of this confrontation, such as “Finally, the user character A and the associated character A1 defeat the confrontation character B”.

For example, the machine learning model can determine winner and loser of this confrontation according to the character attributes such as the hit points of the virtual objects in the team A and the hit point of the confrontation character B in the prompt information, in combination with the skill attributes such as the damage values of the skills casted by the virtual objects in the team A and the damage value of the skill casted by the confrontation character B.

In some embodiments, at least one of a first combining skill attribute of the first virtual object and the first associated virtual object, or a second combining skill attribute of the second virtual object and the second associated virtual object is determined according to the previous plot; and the plot content is generated according to at least one of the first combining skill attribute or the second combining skill attribute.

For example, it is possible to determine, according to a plot related to the user character A and the associated character A1, that in response to the user character A and the associated character A1 forming a team, a combining skill A′ can be casted; and acquire, from the storage database <skill database> for the skills, a skill attribute of the combining skill A′.

The prompt information based on the above information may be input into the machine learning model, to generate plot content for the confrontation of the team A and the confrontation character B, such as “Combination of the user character A with the associated character A1 casts a skill A”.

In this way, the matching degree between the plot content and the current situation can be improved, thereby improving the effect of the human-computer interaction.

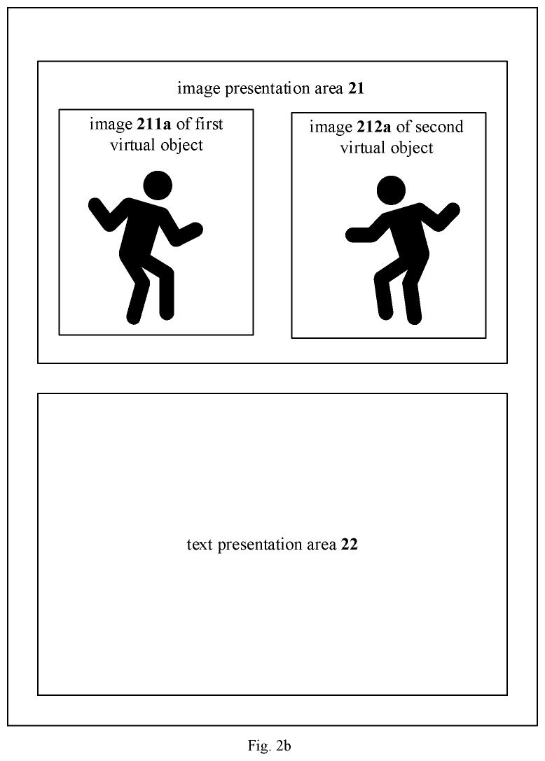

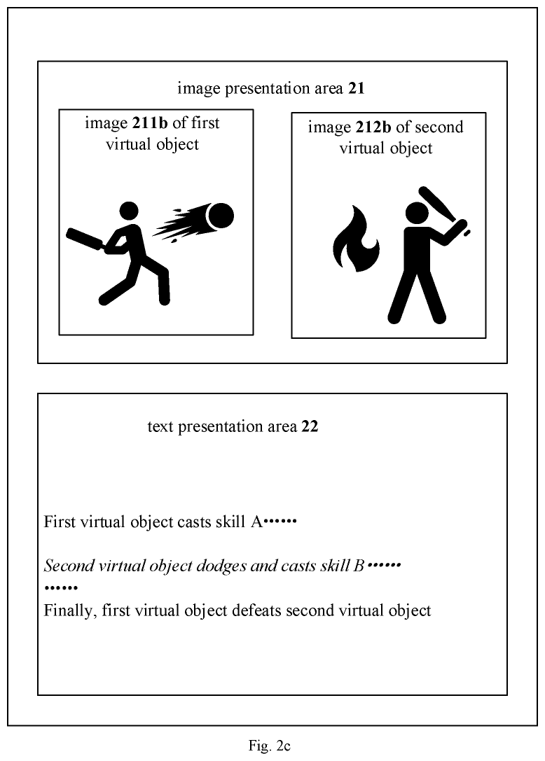

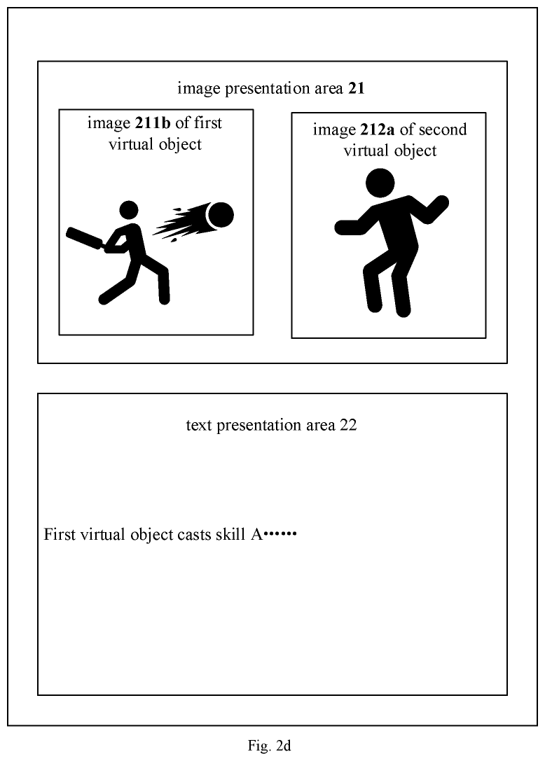

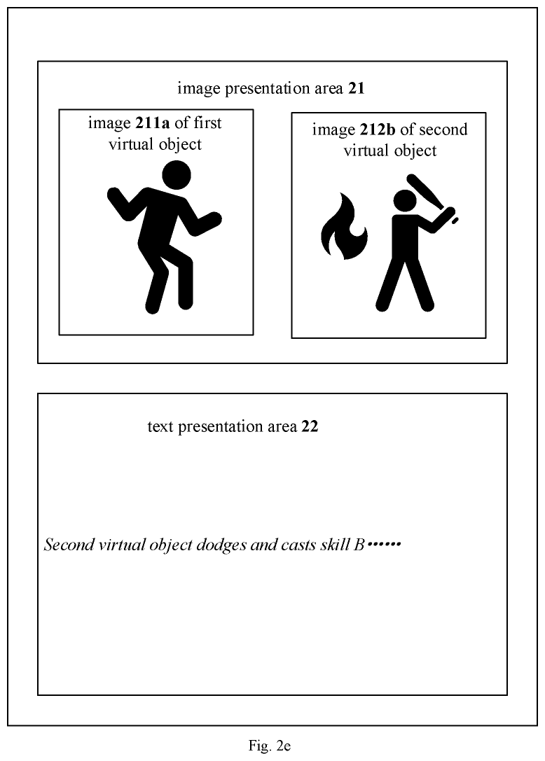

In some embodiments, the plot content is presented to a user. The plot content includes at least one of text content or image content. For example, the plot content can be presented by embodiments in FIGS. 2a-2e.

FIGS. 2a-2e illustrate schematic diagrams of presentation of plot content according to some embodiments of the present disclosure.

As shown in FIG. 2a, an image presentation area 21 is configured to present image content related to plot content, and a text presentation area 22 is configured to present the plot content. For example, the plot content can be presented below the image content, or presented in another layout.

In some embodiments, as shown in FIG. 2b, in response to determining that virtual objects of both parties for confrontation are a first virtual object and a second virtual object, the image presentation area 21 may present initial images of the both parties for confrontation, such as an image 211a of the first virtual object and an image 212a of the second virtual object.

In some embodiments, in the text presentation area 22, plot content for the confrontation of the first virtual object and the second virtual object is presented. For example, the plot content can be generated in the manner described in any of the embodiments above.

In some embodiments, image content presented in the image presentation area 21 may change with the plot content presented in the text presentation area 22, so that the confrontation process is presented more clearly, thereby improving the effect of the human-computer interaction. For example, the image content is video content generated according to a plurality of images. For example, the presentation of the above image content and plot content can be implemented by the embodiments of FIG. 2c.

As shown in FIG. 2c, text content in the text presentation area 22 includes a plurality of paragraphs, which may be presented to a user concurrently. For example, in the case where all the paragraphs cannot be presented concurrently, part of the paragraphs can be presented to the user, and the user can view remaining paragraphs by a page-turning operation.

For example, the text presentation area 22 therein presents plot content regarding the first virtual object and the second virtual object casting respective skills; and the image presentation area 21, corresponding to the plot content, therein presents an image 211b of the first virtual object casting a skill A and an image 212b of the second virtual object casting a skill B.

As shown in FIG. 2c, in response to the text presentation area 22 therein presenting all the paragraphs together, the image presentation area 21 may present image content corresponding to all the paragraphs in a form of a video segment. For example, the image 211b of the first virtual object and the image 212b of the second virtual object correspond to a video segment of the first virtual object casting the skill A and a video segment of the second virtual object casting the skill B, respectively.

In some embodiments, the text content presented in the text presentation area 22 includes a plurality of paragraphs, and the image content includes a plurality of images, each paragraph of the plurality of paragraphs being presented together with a corresponding image. For example, one paragraph of the plurality of paragraphs can be presented to the user each time in an order of occurrence of the plurality of paragraphs, so that the confrontation process is more clearly presented, thereby improving the effect of the human-computer interaction. For example, the paragraphs can be presented one by one by embodiments of FIGS. 2d and 2e, to implement the presentation of the above image content and plot content.

As shown in FIGS. 2d-2e, in the case where paragraphs are presented one by one, it is possible to present an image matched with a confrontation process of one paragraph in the image presentation area 22 in response to the one paragraph being presented in the text presentation area 22. For example, a matched image can be generated according to a currently presented paragraph by using artificial intelligence technology.

In some embodiments, the plot content includes description content of the first virtual object casting a first skill and description content of the second virtual object casting a second skill. For example, in response to a paragraph presented in the text presentation area 22 in FIG. 2d being “The first virtual object casts a skill A”, the image presentation area 21 therein presents an image 211b of the first virtual object casting a skill A that is matched with the paragraph.

In some embodiments, the plot content includes description content of a reaction of the first virtual object to the second skill, and description content of a reaction of the second virtual object to the first skill. For example, in response to a paragraph presented in the text presentation area 22 in FIG. 2e being “The second virtual object dodges and casts a skill B”, the image presentation area 21 therein presents an image 212b of the second virtual object casting a skill B that is matched the paragraph.

For example, the image presentation area 21 may be in a form of continuous presentation of images or in a form of a video.

In some embodiments, content corresponding to the first virtual object and content corresponding to the second virtual object in the text content are different in a text style. For example, the text style can include color, font, size, and the like. In this way, the confrontation process is presented more clearly, thereby improving the effect of the human-computer interaction.

For example, in FIGS. 2c-2e, a paragraph relating to the first virtual object is in non-italics and a paragraph relating to the second virtual object is in italics.

For example, for the both parties for confrontation, presentation of different plots of the both parties can be distinguished in a manner of marking in red.

In some embodiments, under an application scenario of a game main story, the technical solution in any of the above embodiments may be applied to presentation of a fighting scene of a game side story. For example, for a fight between a character controlled by the user and a confrontation character that is involved in the game main story, a text description process of the controlled character and the confrontation character in the fight can be presented by using the technical solution in any of the above embodiments.

In the above embodiments, the confrontation plot can be automatically generated according to the related information of the both parties for the current confrontation, reducing the operation behaviors of the user, and lowering the operation difficulty; and compared with presentation of a pre-prepared fixed plot, flexibility is stronger, enabling the confrontation plot matched with the current situation to be adaptively generated, thereby improving the human-computer interaction effect.

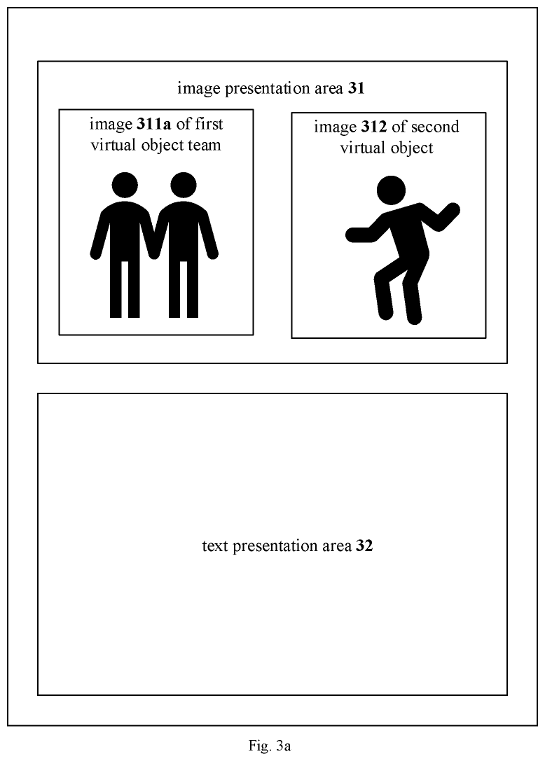

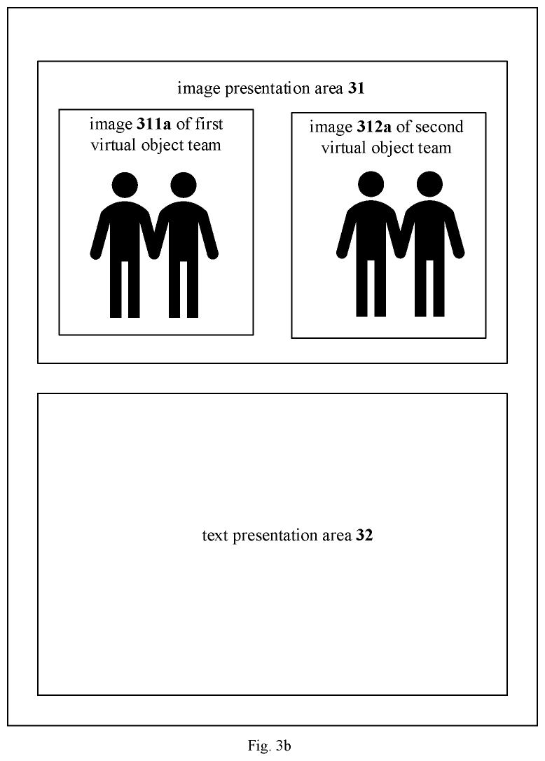

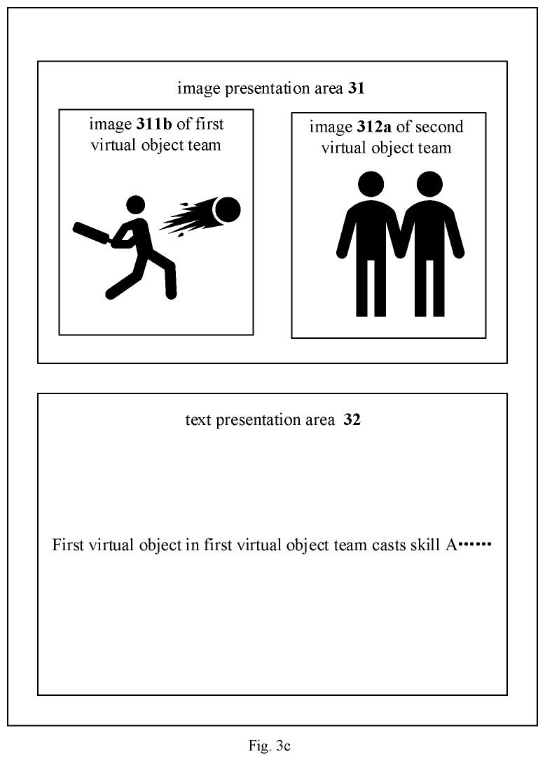

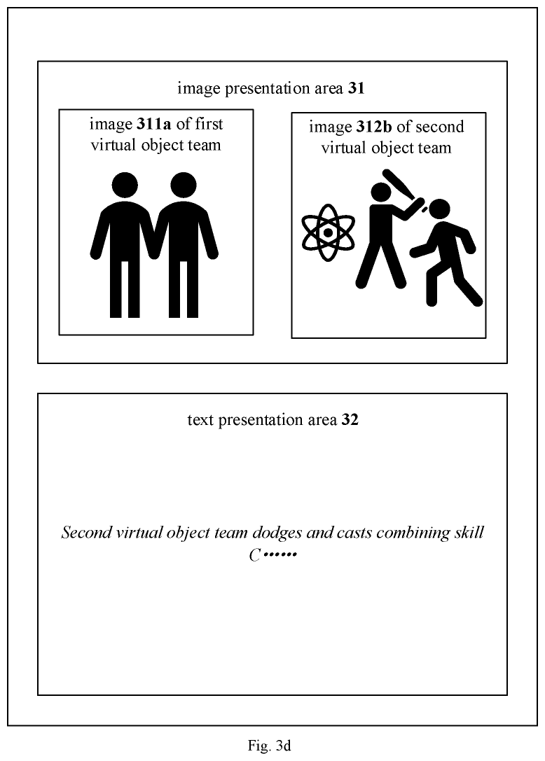

Presentation of plot content in the case of team confrontation is illustrated by embodiments of FIGS. 3a-3d.

FIGS. 3a-3d illustrate schematic diagrams of presentation of plot content according to other embodiments of the present disclosure.

As shown in FIG. 3a, in response to determining that a first associated virtual object can form a first virtual object team with a first virtual object to confront with a second virtual object, an image presentation area 31 can display an image 311a of the first virtual object team, the image 311a including images of the first virtual object and the first associated virtual object; the image presentation area 31 can also display an image 312 of the second virtual object; and a text presentation area 32 is configured to present plot content for the confrontation of the first virtual object team and the second virtual object.

As shown in FIG. 3b, a first associated virtual object can form a first virtual object team with a first virtual object, a second associated virtual object can form a second virtual object team with a second virtual object, and the first virtual object team can confront with the second virtual object team. In this case, the image presentation area 31 may display an image 311a of the first virtual object team, the image 311a including images of the first virtual object and the first associated virtual object; the image presentation area 31 may also display an image 312a of the second virtual object team, the image 312a including images of the second virtual object and the second associated virtual object; and the text presentation area 32 is configured to present plot content for the confrontation of the first virtual object team with the second virtual object team.

For example, FIGS. 3c and 3d illustrate content presented in the image presentation area 31 and the text presentation area 32 in the case where a first virtual object team confronts with a second virtual object team.

As shown in FIG. 3c, plot content currently presented in the text presentation area 32 is “The first virtual object in the first virtual object team casts a skill A”, and the image presentation area 31 presents an image 311b of the first virtual object casting a skill A that is matched with the paragraph.

As shown in FIG. 3d, it is determined that the second virtual object and a second associated virtual object can cast a combining skill C according to a previous plot related to a second virtual object. In this case, plot content currently presented in the text presentation area 32 is “The second virtual object team dodges and casts a combining skill C”, and the image presentation area 31 presents an image 312b of the second virtual object and the second associated virtual object casting the combining skill C that is matched with the paragraph.

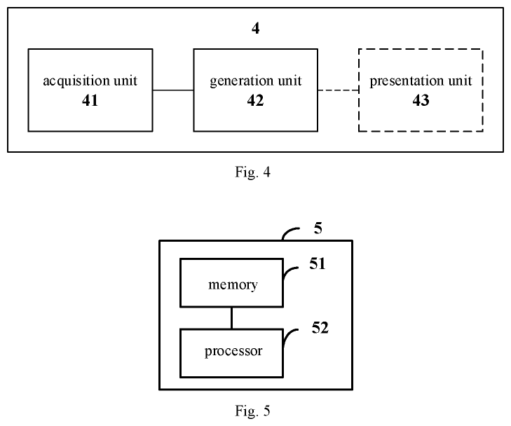

FIG. 4 illustrates a block diagram of a content generation apparatus according to some embodiments of the present disclosure.

As shown in FIG. 4, the content generation apparatus 4 includes: an acquisition unit 41 configured to acquire related information of a first virtual object and related information of a second virtual object for a confrontation, the related information being configured to describe an attribute feature of a virtual object; and a generation unit 42 configured to generate, according to the related information of the first virtual object and the related information of the second virtual object, plot content describing the confrontation of the first virtual object and the second virtual object.

In some embodiments, the related information includes at least one of a character attribute or skill attribute of the virtual object, and the generation unit 42 determines the plot content according to at least one of a result of comparison between a character attribute of the first virtual object and a character attribute of the second virtual object, or a result of comparison between a skill attribute of the first virtual object and a skill attribute of the second virtual object.

In some embodiments, the plot content includes description content of the first virtual object casting a first skill and description content of the second virtual object casting a second skill.

In some embodiments, the plot content includes description content of a reaction of the first virtual object to the second skill and description content of a reaction of the second virtual object to the first skill.

In some embodiments, the character attribute includes current hit point information of a character, and the skill attribute includes skill information acquired by the character in a previous plot of interactive multimedia content.

In some embodiments, the generation unit 42 determines, according to a previous plot of interactive multimedia content, at least one of a first associated virtual object of the first virtual object or a second associated virtual object of the second virtual object, generates the plot content describing confrontation of a first virtual object set and a second virtual object set, the first virtual object set including at least one of the first virtual object or the first associated virtual object, and the second virtual object set including at least one of the second virtual object or the second associated virtual object.

In some embodiments, the generation unit 42 determines, according to the previous plot, at least one of a first combining skill attribute of the first virtual object and the first associated virtual object, or a second combining skill attribute of the second virtual object and the second associated virtual object; and generates the plot content according to at least one of the first combining skill attribute or the second combining skill attribute.

In some embodiments, the generation unit 42 generates content prompt information according to the related information of the first virtual object and the related information of the second virtual object, and generates the plot content using a machine learning model according to the content prompt information.

In some embodiments, the content generation apparatus 4 further includes: a presentation unit 43 configured to present the plot content to a user, the plot content including at least one of text content or image content.

In some embodiments, the image content is generated according to the text content.

In some embodiments, the text content includes a plurality of paragraphs, and the image content includes a plurality of images, each paragraph of the plurality of paragraphs being presented together with a corresponding image.

In some embodiments, the image content is video content generated according to the plurality of images.

In some embodiments, content corresponding to the first virtual object and content corresponding to the second virtual object in the text content are different in a text style.

In some embodiments, the text content includes a plurality of paragraphs, and the presentation unit presents the plurality of paragraphs to the user concurrently, or presents one paragraph of the plurality of paragraphs to the user each time in an order of occurrence of the plurality of paragraphs.

In some embodiments, the plot content includes confrontation process content and confrontation result content.

FIG. 5 illustrates a block diagram of a content generation apparatus according to other embodiments of the present disclosure.

As shown in FIG. 5, the content generation apparatus 5 of this embodiment includes: a memory 51 and a processor 52 coupled to the memory 51, the processor 52 being configured to perform, based on instructions stored in the memory 51, a content generation method in any of the embodiments of the present disclosure.

The memory 51 may include, for example, a system memory, a fixed nonvolatile storage medium, and the like. The system memory has therein stored, for example, an operating system, an application program, a boot loader, a database, and another program.

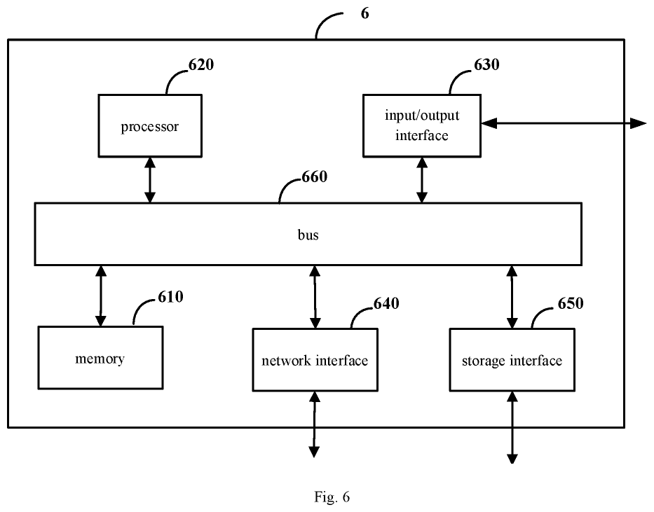

FIG. 6 illustrates a block diagram of a content generation apparatus according to yet other embodiments of the present disclosure.

As shown in FIG. 6, the content generation apparatus 6 of this embodiment includes: a memory 610 and a processor 620 coupled to the memory 610, the processor 620 being configured to perform, based on instructions stored in the memory 610, a content generation method in any of the foregoing embodiments.

The memory 610 may include, for example, a system memory, a fixed non-transitory storage medium, and the like. The system memory has therein stored, for example, an operating system, an application program, a boot loader, and another program.

The content generation apparatus 6 may further include an input/output interface 630, a network interface 640, a storage interface 650, and the like. These interfaces 630, 640, 650 and the memory 610 may be connected with the processor 620, for example, via a bus 660. The input/output interface 630 provides a connection interface for input/output devices such as a display, a mouse, a keyboard, a touch screen, a microphone, and a sound box. The network interface 640 provides a connection interface for a variety of networking devices. The storage interface 650 provides a connection interface for external storage devices such as an SD card and a USB flash disk.

It should be appreciated by those skilled in the art that, the embodiments of the present disclosure may be provided as a method, system, or computer program product. Accordingly, the present disclosure may take the form of an entire hardware embodiment, an entire software embodiment, or an embodiment combining software and hardware aspects. Moreover, the present disclosure may take the form of a computer program product implemented on one or more computer-usable non-transitory storage media having computer-usable program code embodied therein, including, but not limited to, a disk memory, CD-ROM, optical memory, and the like.

So far, the content generation method, the content generation apparatus, and the nonvolatile computer-readable storage medium according to the present disclosure have been described in detail. Some details well known in the art have not been described in order to avoid obscuring the concepts of the present disclosure. Those skilled in the art can fully appreciate how to implement the technical solution disclosed herein according to the foregoing description.

The method and system of the present disclosure may be implemented in a number of ways. For example, the method and system of the present disclosure may be implemented in software, hardware, firmware, or any combination of software, hardware, and firmware. The above order for the steps of the method is for illustration only, and the steps of the method of the present disclosure are not limited to the order specifically described above unless specifically stated otherwise. In addition, in some embodiments, the present disclosure may also be implemented as programs recorded in a recording medium, the programs including machine-readable instructions for implementing the method according to the present disclosure. Thus, the present disclosure also covers a recording medium storing a program for performing the method according to the present disclosure.

Although some specific embodiments of the present disclosure have been described in detail by examples, it should be understood by those skilled in the art that the above examples are for illustration only rather than limiting the scope of the present disclosure. It should be appreciated by those skilled in the art that modifications can be made to the above embodiments without departing from the scope and spirit of the present disclosure. The scope of the present disclosure is defined by the appended claims.

1. A content generation method, comprising:
acquiring related information of a first virtual object and related information of a second virtual object for a confrontation, the related information being configured to describe an attribute feature of a virtual object; and
generating, according to the related information of the first virtual object and the related information of the second virtual object, plot content describing the confrontation of the first virtual object and the second virtual object.

2. The content generation method according to claim 1, wherein the related information comprises at least one of a character attribute or a skill attribute of the virtual object, and
the generating the plot content describing the confrontation of the first virtual object and the second virtual object comprises:
determining the plot content according to at least one of a result of comparison between a character attribute of the first virtual object and a character attribute of the second virtual object, or a result of comparison between a skill attribute of the first virtual object and a skill attribute of the second virtual object.

3. The content generation according to claim 2, wherein the plot content comprises description content of the first virtual object casting a first skill and description content of the second virtual object casting a second skill.

4. The content generation according to claim 3, wherein the plot content comprises description content of a reaction of the first virtual object to the second skill and description content of a reaction of the second virtual object to the first skill.

5. The content generation method according to claim 2, wherein the character attribute comprises current hit point information of a character, and the skill attribute comprises skill information acquired by the character in a previous plot of interactive multimedia content.

6. The content generation method according to claim 1, wherein the generating the plot content describing the confrontation of the first virtual object and the second virtual object comprises:
determining, according to a previous plot of interactive multimedia content, at least one of a first associated virtual object of the first virtual object or a second associated virtual object of the second virtual object; and
generating the plot content describing a confrontation of a first virtual object set and a second virtual object set, the first virtual object set comprising at least one of the first virtual object or the first associated virtual object, and the second virtual object set comprising at least one of the second virtual object or the second associated virtual object.

7. The content generation according to claim 6, wherein the generating the plot content describing the confrontation of the first virtual object set and the second virtual object set comprises:
determining, according to the previous plot, at least one of a first combining skill attribute of the first virtual object and the first associated virtual object, or a second combining skill attribute of the second virtual object and the second associated virtual object; and
generating the plot content according to at least one of the first combining skill attribute or the second combining skill attribute.

8. The content generation method according to claim 1, wherein the generating the plot content describing the confrontation of the first virtual object and the second virtual object comprises:
generating content prompt information according to the related information of the first virtual object and the related information of the second virtual object; and
generating the plot content by using a machine learning model according to the content prompt information.

9. The content generation method according to claim 1, further comprising:
presenting the plot content to a user, the plot content comprising at least one of text content or image content.

10. The content generation method according to claim 9, wherein the image content is generated according to the text content.

11. The content generation method according to claim 9, wherein the text content comprises a plurality of paragraphs, and the image content comprises a plurality of images, each paragraph of the plurality of paragraphs being presented together with a corresponding image.

12. The content generation method according to claim 11, wherein the image content is video content generated according to the plurality of images.

13. The content generation method according to claim 9, wherein content corresponding to the first virtual object and content corresponding to the second virtual object in the text content are different in a text style.

14. The content generation method according to claim 9, wherein the text content comprises a plurality of paragraphs, and
the presenting the plot content to the user comprises:
presenting the plurality of paragraphs to the user concurrently; or
presenting one paragraph of the plurality of paragraphs to the user each time in an order of occurrence of the plurality of paragraphs.

15. The content generation method according to claim 1, wherein the plot content comprises confrontation process content and confrontation result content.

16. (canceled)

17. (canceled)

18. A content generation apparatus, comprising:
a memory; and
a processor coupled to the memory, the processor being configured to perform, based on instructions stored in the memory, a content generation method comprising:
acquiring related information of a first virtual object and related information of a second virtual object for a confrontation, the related information being configured to describe an attribute feature of a virtual object; and
generating, according to the related information of the first virtual object and the related information of the second virtual object, plot content describing the confrontation of the first virtual object and the second virtual object.

19. A non-transitory computer-readable storage medium having thereon stored a computer program which, when executed by a processor, implementing a content generation method comprising:
acquiring related information of a first virtual object and related information of a second virtual object for a confrontation, the related information being configured to describe an attribute feature of a virtual object; and
generating, according to the related information of the first virtual object and the related information of the second virtual object, plot content describing the confrontation of the first virtual object and the second virtual object.

20. (canceled)

21. The content generation apparatus according to claim 18, wherein the related information comprises at least one of a character attribute or a skill attribute of the virtual object, and
the processor implements a following step:
determining the plot content according to at least one of a result of comparison between a character attribute of the first virtual object and a character attribute of the second virtual object, or a result of comparison between a skill attribute of the first virtual object and a skill attribute of the second virtual object.

22. The content generation apparatus according to claim 18, wherein the plot content comprises description content of the first virtual object casting a first skill and description content of the second virtual object casting a second skill.

23. The content generation apparatus according to claim 18, wherein the plot content comprises description content of a reaction of the first virtual object to the second skill and description content of a reaction of the second virtual object to the first skill.
